(19) United States
(12) Patent Application Publication
(10) Pub. No.: US 2013/0294025 A1
(43) Pub. Date: Nov. 7, 2013

(54) Expansion Circuit Board Cooling

(71) Applicant: Niall Thomas Davidson, Hamilton (GB)

(72) Inventor: Niall Thomas Davidson, Hamilton (GB)

(21) Appl. No.: 13/465,053

(22) Filed: May 7, 2012

(51) Int. Cl. G06F 1/20; F28F 7/00

(52) U.S. Cl. 361/679.32; 165/185

(57) ABSTRACT

Method and apparatus for cooling components on an expansion circuit board, heat is transmitted from components on the expansion circuit board to a thermal connector via heatpipes or other heat transmitting means, the thermal connector configured to communicate heat to a counterpart thermal connector when the expansion circuit board is installed.

### CROSS-REFERENCE TO RELATED APPLICATIONS

The present application is related to copending application entitled “Cooled Part for Expansion Circuit Board Cooling” filed on the same day as the present application by inventor Niall T. Davidson, the application entitled “Cooled Part for Expansion Circuit Board Cooling” is not admitted to be prior art with respect to the present invention by its mention in the background or cross-reference section.

### BACKGROUND

Expansion circuit boards are widely used in electronic systems, examples of electronic systems which make extensive use of expansion circuit boards are server computer systems and personal computer systems which use expansion circuit boards in the form of expansion cards which install into expansion slots to extend the computers capabilities and provide additional features. Designers of the expansion slots used in such computers provide electrical and mechanical specifications so that interested third-parties can design and build expansion cards that will work in these slots.

There are many examples of expansion cards on the market today, these include graphics cards, network cards, IO cards and many more. Some expansion cards are no more than a circuit board with a few ICs, whilst others provide access to sophisticated processors that are sold with cooling hardware attached to prevent overheating.

Expansion cards which are sold with their own cooling solutions include graphics cards, general purpose GPU compute devices, hardware RAID and high end network cards, these cards use cooling solutions that range from a single heatsink to a combination of heatsinks, fans and other cooling apparatus. Due to the positioning of expansion slots and the proximity of other expansion cards these cooling solutions must perform within a restricted space which may not be favorable for the task and heat dissipated by some of these cooling systems increases the temperature inside the enclosure which in turn increases the temperature of other components and can lead to additional cooling fans being added to the enclosure to reduce the temperature of the enclosure and provide adequate airflow.

The cooling solutions used by some expansion cards can increase their size and weight significantly and some cards take up so much space that their installation precludes the use of neighboring expansion slots. Additionally, the use of fans significantly increases the noise output of the computer, introduces a point of mechanical failure and, because of the space limitations, are limited in size and therefore are louder and potentially less efficient than they could be otherwise.

An alternative method of cooling components on expansion circuit boards is therefore desirable.

### SUMMARY

The present invention is directed to a method and apparatus that satisfy this need, one embodiment of the present invention comprises a thermal connector which is adapted to attach to an expansion circuit board. When attached to the expansion circuit board heat from one or more components on the expansion circuit board is communicated to the thermal connector and the thermal connector is configured such that when the expansion circuit board is installed the thermal connector is brought into contact with a counterpart thermal connector, creating a thermal path between the components and the counterpart thermal connector. By cooling the counterpart thermal connector heat flows from the components on the expansion circuit board to the counterpart thermal connector and the components are cooled.

Advantages of the present invention include, but are not limited to, a reduction in the number of fans and other cooling hardware required to cool an expansion circuit board and therefore an associated reduction in noise, risk of mechanical failure, design complexity and space required for cooling hardware.

Further, by communicating heat away from the expansion circuit board, alternative and more efficient cooling techniques become viable. This is beneficial for electronic systems in general as heat management becomes more predictable and alternative cooling techniques such as liquid cooling are simplified, general purpose computers and computer systems intended for deployment in data centers can both benefit from this. The copending application entitled “Cooled Part for Expansion Circuit Board Cooling” describes apparatus which takes advantage of apparatus having features of the present invention.

### DRAWINGS

These and other features, aspects, and advantages of the present invention will become better understood with regard to the following description, appended claims, and accompanying drawings where:

FIGS. 1, 2 and 3 show exploded views of example thermal connectors and their respective counterpart thermal connectors;

FIG. 4 shows an exploded view of an apparatus embodying features of the present invention, the apparatus adapted for use with a computer system expansion card;

FIG. 5 shows an example of a computer system expansion card with the apparatus of FIG. 4 attached;

FIG. 6 shows the expansion card of FIG. 5 installed in a computer system, and;

FIGS. 7 to 11 show further examples of computer system expansion cards embodying features of the present invention.

### DESCRIPTION

It is intended that the following description and claims should be interpreted in accordance with Webster's Third New International Dictionary, Unabridged unless otherwise indicated.

In the following specification and claims the term “expansion circuit board”, includes but is not limited to: computer system expansion cards, daughter boards, mezzanine boards, riser cards, piggyback boards and any other circuit board designed to be installed in an electronic system or into a chassis.

In the following specification and claims a “heatpipe” is intended to encompass heatpipes, vapor chambers and other heat transfer devices which operate in a similar manner.

In the following specification and claims a “thermal connector” is defined to be an apparatus, article of manufacture or portion of an expansion circuit board the purpose of which is to transfer, transmit or communicate heat to a counterpart thermal connector when contacted with or otherwise interacting with the counterpart thermal connector. Examples of thermal connectors and their counterparts are shown in FIGS. 1, 2 and 3, however it is not intended that the definition of a thermal connector be limited to the shape and form of the examples shown, nor that they are limited to operating via physical contact, nor is it necessary that a thermal connector is distinct, it may for instance be part of an expansion circuit board which is brought into contact with a counterpart to transfer, transmit or communicate heat, or it may be a component which generates heat and is positioned as to act in accordance with the teachings of the present invention. A person having ordinary skill in the art will be able to devise numerous and diverse thermal connectors which can be used by apparatus embodying features of the present invention.

In the following specification and claims I have attempted to maintain the convention of referring to a thermal connector found on an expansion circuit board as the “thermal connector”, whilst referring to a thermal connector to which the thermal connector on an expansion circuit board contacts as the “counterpart thermal connector”, however both are still thermal connectors and the use of “counterpart thermal connector” or “thermal connector” does not imply a specific purpose or meaning and should not be taken as such.

FIG. 1 shows an example of a thermal connector 100 and its counterpart thermal connector 102 manufactured from a thermally conductive material. When the thermal connector 100 and its counterpart 102 are brought together a thermal interface 104 is created and a thermal circuit completed which allows heat to flow across the thermal interface 104. Optionally, to improve the quality of the thermal connection, a fastener such as screws 106 and springs 108 can be used to provide pressure and hold the two parts together. Thermal connector 100 offers a detachable connection, has a thermal interface 104 which is easy to clean and apply thermal interface material to, is relatively simple to manufacture and has a high tolerance for misalignment between the thermal connector 100 and its counterpart.

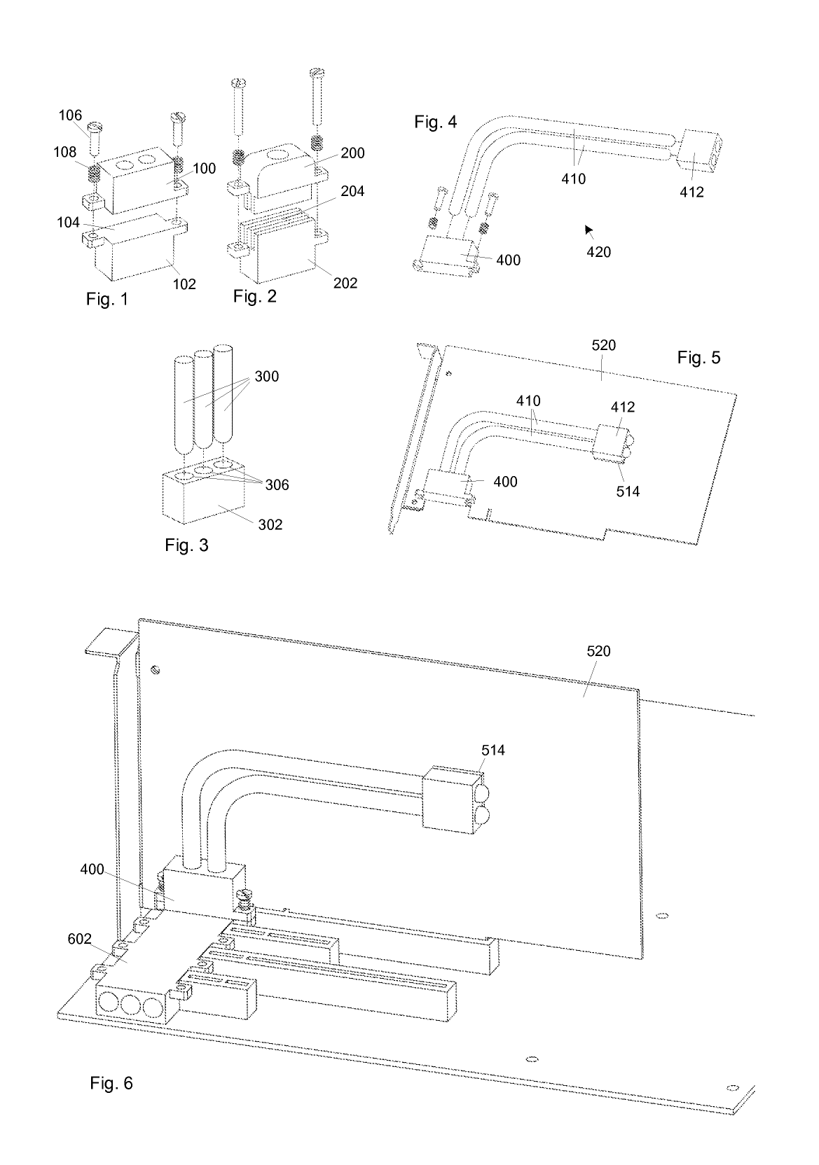

FIG. 2 shows another example of a thermal connector manufactured from a thermally conductive material, thermal connector 200 and its counterpart thermal connector 202 employ the use of finned profiles which fit together and create a thermal interface 204 across which heat can flow when brought together. Thermal connector 200 offers a detachable connection and has a thermal interface 204 with a large surface area.

FIG. 3 shows another example of a thermal connector, thermal connectors 300 are inserted into the apertures 306 to make a thermal connection. Each thermal connector 300 is the end of a heat pipe and has a corresponding aperture 306 in the counterpart thermal connector 302 into which it fits. The thermal connector of FIG. 3 has the advantage that it offers a detachable connection, and offers a direct thermal interface to a heat transfer means, thus reducing the number of thermal interfaces in the system, it also offers the capability to use a number of thermal connectors 300 less than there is apertures 306, thus allowing an expansion circuit board to use only as many thermal connectors 300 as it requires.

A method of cooling components on an expansion circuit board is described, the method comprising: transmitting heat generated by a component on the expansion circuit board to a thermal connector, and optionally cooling the thermal connector.

The step of transmitting heat generated by a component on the expansion circuit board to a thermal connector can be achieved in many ways, for example heat pipes, vapor chambers, circuit board traces, thermal interface material and thermally conductive materials, composites, manufactures and apparatus such as: thermally conductive metals examples of which include copper, aluminium, beryllium, silver, gold, nickel and alloys thereof; thermally conductive non-metallic materials examples of which include diamond, carbon fiber, carbon nanotubes, graphene, graphite and combinations thereof; composite materials and manufactures examples of which include graphite fiber/copper matrix composites and the encapsulated graphite system sold under the trademark k-Core by k Technology of Langhorne Pa., and; apparatus such as liquid cooling, heat pumps and heat exchangers can all be used alone or in combination to transmit heat from a component on the expansion board to a thermal connector. It is intended that a means for transmitting heat encompass the preceding and any structure presently existing or developed in the future that performs the same function. A person having ordinary skill in the art will be able to devise numerous and diverse means for transmitting heat from components to a thermal connector and the examples described are illustrative only and are not intended to limit a means for transmitting heat to such.

The step of cooling the thermal connector is achieved by the interaction of the thermal connector and its counterpart, in the case of a thermal connector which communicates heat via physical contact an example of how to do this is to position the thermal connector such that when the expansion circuit board is installed the thermal connector is brought into contact with a cooled counterpart thermal connector, thus creating a thermal connection through which heat can flow, cooling the thermal connector and the component. For example a thermal connector on a computer system expansion card can be brought into contact with a cooled counterpart thermal connector when installed, an example of this is shown in FIG. 6 where the thermal connector 400 is shown contacting the cooled counterpart thermal connector 602 when the expansion card is installed. Alternatively the thermal connector can be contacted with a cooled part before or after installation.

Apparatus embodying features of the present invention comprise a thermal connector and an optional means for transmitting heat, the means for transmitting heat transmits heat from one or more components on the expansion circuit board to the thermal connector. The thermal connector is configured to be contacted to a cooled part or counterpart thermal connector.

Examples of apparatus embodying features of the present invention are described, whilst the examples given are in the context of computer system expansion cards it is not intended that the teachings of this document be limited to expansion circuit boards of this form and it is expected that apparatus embodying principles of the present invention will be useful for many other electronic systems. The described examples have thermal connectors of a specific type, the use of a specific thermal connector is exemplary only and apparatus having features of the present invention are not limited to the type or form of thermal connector described.

FIG. 4 shows an exploded view of an apparatus 420 embodying principles of the present invention, the apparatus 420 adapted to be attached to an expansion card intended for installation in a computer system. The apparatus 420 comprising a thermal connector 400 and a means for transmitting heat from a component on an expansion card to the thermal connector 400, the means for transmitting heat comprising a heat spreader 412 and heat pipes 410 which communicate heat from the heat spreader 412 to the thermal connector 400.

The apparatus 420 is adapted such that when fitted to an expansion card the heat spreader 412 is contacted with a component on the expansion card and the thermal connector 400 is positioned to contact a counterpart thermal connector when the expansion card is installed and to break contact with the counterpart thermal connector when the expansion card is removed, or uninstalled. FIG. 5 shows a view of the assembled apparatus 420 fitted to an expansion card 520, the heat spreader 412 contacting a component 514 and the thermal connector 400 positioned to make contact with a counterpart thermal connector when the expansion card 520 is installed.

FIG. 6 shows the expansion card 520 installed in a computer system with the thermal connector 400 in contact with a counterpart thermal connector 602, a thermal circuit being created between the component 514 and the counterpart thermal connector 602. With the thermal circuit complete, cooling of the component 514 can be achieved by cooling the counterpart thermal connector 602.

FIG. 6 also illustrates a possible use of apparatus embodying features of the present invention in the context of a computer system. The counterpart thermal connector 602 is cooled, which due to the thermal connector 400 cools the component on the expansion card 520 when installed. If other expansion cards similar to the expansion card 520 were installed in the vacant expansion slots, the counterpart thermal connector 602 would be capable of cooling those too. Thus a system can be created which is capable of cooling one or more expansion cards by cooling the counterpart thermal connector 602. The copending application entitled “Cooled Part for Expansion Circuit Board Cooling” describes apparatus which is capable of cooling one or more expansion cards in this manner.

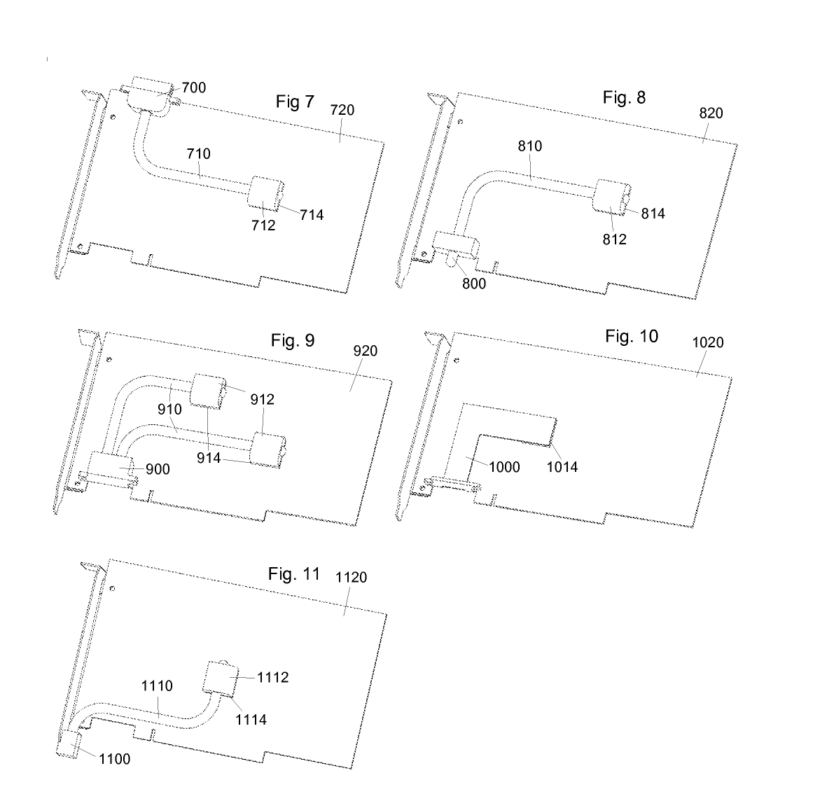

FIG. 7 shows an apparatus embodying features of the present invention attached to an expansion card 720. The apparatus comprising a finned thermal connector 700 and a means for transmitting heat comprising heat pipe 710 and heat spreader 712, the heat spreader 712 connected to a component 714. The finned thermal connector 700 adapted to be contacted by a counterpart thermal connector.

FIG. 8 shows an apparatus embodying features of the present invention attached to an expansion card 820. The apparatus comprising a thermal connecter 800, of a type similar to that exhibited in FIG. 3, which comprises an end of a heat pipe 810 and a means for transmitting heat comprising the heat pipe 810 and heat spreader 812 which is connected to a component 814. The thermal connector 800 being configured to fit into a counterpart thermal connector when the expansion card 820 is installed.

FIG. 9 shows an apparatus embodying features of the present invention attached to an expansion card 920. The apparatus comprising a thermal connector 900 and a means for transmitting heat comprising heat pipes 910 and heat spreaders 912, the heat spreaders 912 connected to the components 914. The thermal connector 900 being adapted in such a way that it will contact a counterpart thermal connector when the expansion card 920 is installed.

FIG. 10 shows an apparatus embodying features of the present invention attached to an expansion card 1020. The apparatus comprising thermally conductive material shaped to function as both thermal connector 1000 and means for transmitting heat from component 1014 which it is in contact with. The thermal connector 1000 is adapted such that it will contact a counterpart thermal connector when the expansion card 1020 is installed.

FIG. 11 shows an apparatus embodying features of the present invention attached to an expansion card 1120. The apparatus comprising a thermal connector 1100 integrated with the attachment bracket of the expansion card and a means for transmitting heat comprising heat pipe 1110 and heat spreader 1112, the heat spreader 1112 contacted to component 1114. The thermal connector 1100 is adapted such that it will contact a counterpart thermal connector when the expansion card 1120 is installed.

The embodiments illustrated in FIGS. 4, 9 and 10 show thermal connectors which are positioned in a similar location and can all be brought into contact with the same form of counterpart thermal connector, this allows us to illustrate a potential benefit of apparatus embodying features of the present invention. If the expansion cards 420, 920 and 1020 are designed to install in the same type of expansion slot we can see that whilst the expansion cards comprise different heat transmitting means, have possibly different heat dissipation requirements and may be manufactured by different manufacturers, that if a type and position is specified for a counterpart thermal connector then any of these card could be installed into an expansion slot and connect via a thermal connector to the specified counterpart thermal connector and receive cooling.

This provides an opportunity for expansion slot specifications to specify not only electrical and mechanical characteristics but additionally a counterpart thermal connector type and position, and therefore a standardized configuration for a cooled part which third-parties can then use to manufacture expansion cards. Other standards bodies may also benefit from creating similar standards which expansion circuit boards embodying features of the present invention can be designed to take advantage of.

Although specific embodiments of the invention have been shown and described herein, it is to be understood that these embodiments are merely illustrative of the many possible specific arrangements that can be devised in application of the principles of the invention. Numerous and varied other arrangements can be devised by those of ordinary skill in the art without departing from the scope and spirit of the invention.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specified function, is not to be interpreted as a “means” or “step” clause as specified in 35 U.S.C. §112, ¶6. In particular, the use of “step of” in the claims herein is not intended to invoke the provisions of 35 U.S.C §112, ¶6.

What I claim is:

1. A method for cooling components on an expansion circuit board, the method comprising transmitting heat generated by a component on the expansion circuit board to a thermal connector.

2. The method of claim 1 further comprising cooling the thermal connector.

3. The method of claim 2 wherein the step of cooling the thermal connector comprises contacting the thermal connector with a cooled part when the expansion circuit board is installed.

4. The method of claim 1 wherein the thermal connector is configured in such a way that installing the expansion circuit board causes the thermal connector to be brought into contact with a counterpart thermal connector.

5. The method of claim 4 wherein the thermal connector is further configured such that removing the expansion circuit board from its installed position causes the thermal connector to break contact with the counterpart thermal connector.

6. The method of claim 4 wherein the configuration of the counterpart thermal connector is standardized.

7. The method of claim 4 wherein the expansion circuit board is an expansion card for a computer system and installing the expansion card comprises installation of the expansion card in a computer system.

8. A heat transfer apparatus adapted to be attached to an expansion circuit board, the apparatus comprising a thermal connector.

9. The heat transfer apparatus of claim 8 wherein the thermal connector is configured to be brought into contact with a counterpart thermal connector when the expansion circuit board is installed.

10. The heat transfer apparatus of claim 9 wherein the thermal connector is further configured to break contact with the counterpart thermal connector when the expansion circuit board is removed from its installed location.

11. The heat transfer apparatus of claim 9 further comprising heat transmission means, the heat transmission means configured to transmit heat from a component on the expansion circuit board to the thermal connector.

12. The heat transfer apparatus of claim 9 wherein the thermal connector is a thermally conductive surface.

13. The heat transfer apparatus of claim 8 wherein the thermal connector is configured to be contacted by a counterpart thermal connector when the expansion circuit board is installed.

14. The heat transfer apparatus of claim 8 further comprising heat transmission means, the heat transmission means configured to transmit heat from a component on the expansion circuit board to the thermal connector.

15. The heat transfer apparatus of claim 8 adapted to be attached to an expansion card for a computer system.

16. An expansion circuit board with the heat transfer apparatus of claim 8 attached.

17. An expansion card comprising:
a. means for transmitting heat, and;
b. a thermal connector, the means for transmitting heat transmitting heat to the thermal connector, the thermal connector configured to contact a counterpart thermal connector when the expansion card is installed.

18. The expansion card of claim 17 wherein the thermal connector makes contact with the counterpart thermal connector when the expansion card is inserted into the expansion slot.

19. The expansion card of claim 18 wherein the thermal connector breaks contact with the counterpart thermal connector when the expansion card is removed from the expansion slot.

20. The expansion card of claim 18 wherein the thermal connector is a thermally conductive surface.

21. The expansion card of claim 17 wherein the configuration of the counterpart thermal connector is specified as part of an industry specification.

22. The expansion card of claim 17 wherein the means for transmitting heat comprises a heatpipe.

23. A computer system with the expansion card of claim 17.

24. The expansion card of claim 17 wherein the thermal connector comprises a heatpipe.
